(19) United States
(12) Patent Application Publication
(10) Pub. No.: US 2009/0222212 A1
(43) Pub. Date: Sep. 3, 2009

(54) ANALYSIS OF MIXED SOURCE DNA PROFILES

(75) Inventor: James Curran, Birmingham (GB)

Correspondence Address: MERCHANT & GOULD PC, P.O. BOX 2903, MINNEAPOLIS, MN, 55402-0903, US

(73) Assignee: Forensic Science Services Ltd., Solihull (GB)

(21) Appl. No.: 12/296,041

(22) PCT Filed: Mar. 28, 2007
(86) PCT No.: PCT/GB2007/001125

§ 371 Date: Apr. 14, 2009

(30) Foreign Application Priority Data
Apr. 3, 2006 (GB) 0606666.6
Apr. 5, 2006 (GB) 0606866.2

(51) Int. Cl. G06F 19/00

(52) U.S. Cl. 702/19

(57) ABSTRACT

A method of analysing DNA samples from mixed sources includes i) obtaining an observed result relating to a value set for a characteristic of the DNA; ii) randomly selecting a selected value set for that DNA characteristic and generating an expected result from that selected value set; iii) comparing the observed result and the expected result and quantifying the difference there between. The method also includes iv) considering the selected value set to be the optimal match; v) randomly selecting a different selected value set and generating another expected result from that selected value set; vi) comparing the observed result with the another expected result and quantifying the difference there between; vii) replacing the existing optimal value set with the different selected value set of step v) if a criteria is met. The method further includes viii) repeating steps v), vi) and vii) at least 10 times; ix) the last optimal match being taken to be the optimal match for the value set for the DNA.

This invention concerns improvements in and relating to analysis, particularly, but not exclusively analysis of mixed source DNA profiles.

The applicant has developed a software product, PENDULUM, which analyses DNA profiles from mixed sources to establish mixing proportions for the sources and establish likely genotypes for the sources. Such information is useful in a variety of legal and law enforcement applications.

The existing approach has limitations when trying to analyse profiles in certain circumstances, for instance where large numbers of loci are considered.

According to a first aspect of the invention we provide a method of analysing, the method including

i) obtaining from an analysis of a DNA containing sample an observed result, the observed result relating to a value set for a characteristic of the DNA;

ii) randomly selecting a selected value set for that DNA characteristic and generating an expected result from that selected value set;

iii) comparing the observed result and the expected result and quantifying the difference there between;

iv) considering the selected value set to be the optimal match for the value set for the DNA of the DNA containing sample;

v) randomly selecting a different selected value set for that DNA characteristic and generating another expected result from that selected value set;

vi) comparing the observed result with the another expected result and quantifying the difference there between;

vii) replacing the existing value set considered to be the optimal configuration with the different selected value set of step v) if a criteria is met;

viii) repeating steps v), vi) and vii) at least 10 times;

ix) the last optimal match being taken to be the optimal match for the value set for the DNA of the DNA containing sample.

The analysis of the DNA sample may be provided as an initial step in the method. The observed result may be obtained directly from the analysis. Alternatively or additionally the observed result may be obtained indirectly. The observed result may be stored before use, for instance in a database. The observed result may be the output of a DNA analyser.

The DNA containing sample may be a mixed sample. The mixed sample may arise from 2 persons. The mixed sample may arise from more than 2 persons.

The observed result may be a DNA profile. The observed result may relate to one or more peak areas or peak heights at one or more allele sizes for one or more loci. One, two, three or four peak heights/areas may occur for one or more of loci. The observed result may relate to one loci or to a plurality of loci. The observed result may be the result of analysis of the DNA containing sample using a multiplex.

The value set may be the allele identities in that sample for one or more loci. The characteristic may be the one or more loci under consideration.

The observed result may reflect the mixing proportion of the different contributors to the mixed sample. The mixing proportion may be unknown.

The selected value set may be selected at random from amongst all possible selected value sets. A locus may be selected at random, with a selected value set being selected at random from amongst all possible value sets for that locus. A locus may be selected at random, with all possible selected values sets for that locus then being considered, preferably they are considered systematically. The available loci are preferably constrained to the loci considered in the analysis of the DNA containing sample. The method may be repeated across one or more further loci, selected at random, preferably from amongst the remaining loci not already considered by the method.

The selected value set may be selected at random from amongst a sub-set of all possible selected value sets. The sub-set may be formed by constraining compared with all possible selected value sets. The constraining may be provided by excluding possible selected value sets for which one or more criteria are not met. The criteria may not be met where the threshold for heterozygous balance is exceeded. The constraining may be provided by excluding one or more of the possible loci from being selected. Excluding loci may be included in the method later by obtaining an initial optimal match using the method, and then performing steps v), vi), vii) and viii) in respect of one or more of those excluded loci.

The selected value set may be selected at random from amongst a sub-set of all possible selected value sets. The sub-set may be formed by choosing a locus at random, with the selected value set being the value set which provides the optimal match and/or minimal residual across all loci considered in the method and/or considered in the analysis of the DNA containing sample. In an alternative, but less preferred form, the sub-set may be formed by starting at a first locus, obtaining an optimal match and/or minimal residual for that, moving on to another loci, obtaining an optimal match and/or minimal residue for that.

The value set may be the allele identities in that sample for one or more loci. The characteristic may be the one or more loci under consideration.

The expected result may be a simulated DNA profile. The expected result may relate to one or more simulated peak areas or peak heights at one or more allele sizes for one or more loci. One, two, three or four simulated peak heights and/or areas may occur for one or more of loci. The expected result may relate to one loci or to a plurality of loci. The expected result may be a simulation of the result of analysis of a DNA containing sample using a multiplex, particularly a simulation of a mixed DNA containing sample. The expected result may simulate the mixing proportion of the different contributors to the mixed sample.

The expected result may be determined by the one or more peak areas for the locus and/or the selected value set, preferably as a genotype, and/or a factor relating to the mixing proportion.

The observed result and the expected result may have the difference between them quantified using a least squares approach.

The first selected value set may be considered to be an optimal match irrespective of the difference quantified. The first selected value set is preferably replaced by another selected value set as a result of step vii) in the method.

The different selected value set may be selected at random from amongst all possible selected value sets. The different selected value set may be selected at random from amongst a sub-set of all possible selected value sets. The sub-set may be formed by constraining compared with all possible selected value sets. The constraining may be provided by excluding possible selected value sets for which one or more criteria are not met. The criteria may not be met where the threshold for heterozygous balance is exceeded. The constraining may be provided by excluding one or more of the possible loci from being selected. Excluding loci may be included in the method later by obtaining an initial optimal match using the method, and then performing steps v), vi), vii) and viii) in respect of one or more of those excluded loci.

The observed result and the another expected result preferably have the difference between them quantified by the same approach as is used in step iii). For instance, the difference between them may be quantified using a least squares approach.

The criteria of step vii) may be met where the quantification of the difference is smaller for that value set compare with that for the value set considered to be the optimal configuration before that value set was considered. The step may follow the form, let the value set be denoted x and let the difference between the expected result and observed result for that value set be f(x), let a further value set be denoted x′, let the difference between the expected result and the observed result for that value set be denoted f(x′), and when f(x′)<f(x), then let x′ be the new optimal match. The method may provided that the criteria of step vii) is only met in a fraction of instances in which the quantification of the difference is smaller for that value set compare with that for the value set considered to be the optimal configuration before that value set was considered. A value set may be accepted according to step vii) where the difference is greater than for the previous value set representing the optimal match in a fraction of cases. The fraction may decrease as the number of repeats of steps v), vi) and vii) that has passed increases. The fraction may decrease in a stepwise manner or in a constant manner.

The method preferably provides for at least 100 repeats of steps v), vi) and vii). The method preferably provides for at least 200 repeats of steps v), vi) and vii). The method preferably provides for at least 500 repeats of steps v), vi) and vii). The method preferably provides for at least 1000 repeats of steps v), vi) and vii).

The method may repeat steps ii), iii), iv), v), vi), vii) and viii) a plurality of times before determining the solution of step ix). The plurality of times may be at least 5. The method preferably provides for the same number of repeats of steps v), vi) and vii) each of the plurality of times, but the number may be different between one or more occasions, and even between all. Preferably the starting locus and/or starting value set is different in each of the plurality of times.

The optimal match preferably details the selected value set which best match's the selected value set for the observed result. The selected value set may detail the mixing proportion of the contributors. The selected value set may detail one or more alleles for one or more contributors at one or more loci. Preferably the selected value set details all the alleles, preferably for all the contributors, preferably for all the loci considered.

The last optimal match may form the starting point for the generation of a number of further possible matches. The further possible matches may be ranked according to likelihood and/or the difference quantification. The further possible matches may number at least 25, potentially at least 100 and more preferably at least 400.

The set of further possible values, including the optimal match may be searched against one or more databases, for instance The National DNA Database, RTM.

The further possible matches may include one or more value sets considered in the method for reaching the optimal match, but not being retained as the optimal match. The further possible matches may be generated from a last optimal match by applying a perturbation to the optimal match. One or more first order and/or second order and/or higher order perturbations may be applied. A first order perturbation in which one allele identity and/or all allele identities at one loci is changed compared with the optimal allele identities may be considered. All possible such perturbations may be considered. A random sample of the possible first order perturbations may be considered. A second order perturbation in which one allele identity and/or all allele identities at two loci is changed compared with the optimal allele identities may be considered. All possible such perturbations may be considered. A random sample of the possible second order perturbations may be considered.

The difference between the expected result for each perturbation and the observed result may be quantified. Preferably a number of the further matches meeting a criteria are selected, ideally to form a ranked list. The criteria may be the N further possible matches which have the lowest difference compared with the observed result, where N is a positive integer. N may be at least 25, more preferably at least 100 and most preferably at least 400. Perturbations of a higher order than first or second may be used if the first and second order perturbations do not generate the required level of N or do not generate the required level of below a threshold value for the quantification of the difference. Preferably third order perturbations are used first for this purpose.

The method may be used in a first set of circumstances, with an alternative method being used in a second set of circumstances. The first set of circumstances may be a number of loci for which the DNA is analysed or which are included in the observed result. The number may be a number greater than a threshold number. The threshold number may be 15, may be 13 or may be 11. The first set of circumstances may be a number of loci having one of a group of properties. The number of loci may be 3 or more, particularly 4 or more. The properties placing a loci in the group of properties may include one or more of the following: loci for which 2 peaks only are observed in the observed result; loci for which 3 peaks only are observed in the observed result; loci for which there are 7 possible combinations for assigning alleles between the two contributors to the observed result; loci for which there are 12 possible combinations for assigning alleles between the two contributors to the observed result.

The second set of circumstances may be circumstances other than those provided by the first set of circumstances.

The alternative method may include considering a test genotype. The test genotype may be expressed in terms of an expected result. The test genotype may be expressed in terms of an expected profile. The test genotype may be expressed in terms of one or more expected peak areas, potentially for one or more allele sizes. The expected result may be compared with an observed result. The expected profile may be compared with an observed profile. The expected peak area for one or more allele sizes may be compared with an observed peak area for one or more, preferably the same, allele sizes. The difference between the expected and the observed may be determined. Every possible test genotype may be considered in this way. A number of different mixing proportions may be applied to each possible genotype, with each then being considered in this way. A number of loci may be considered, with each possible genotype for each being considered in this way. Those test genotypes for whom the difference between the expected and observed is below a threshold value and/or which are in the n lowest differences may be noted. The n=500 lowest may be noted. Preferably these are the differences when that genotype is considered across the various loci and/or for which the possible mixing proportions have been accounted for.

Various embodiments of the invention will now be described, by way of example only, and with reference to the accompanying drawings in which:

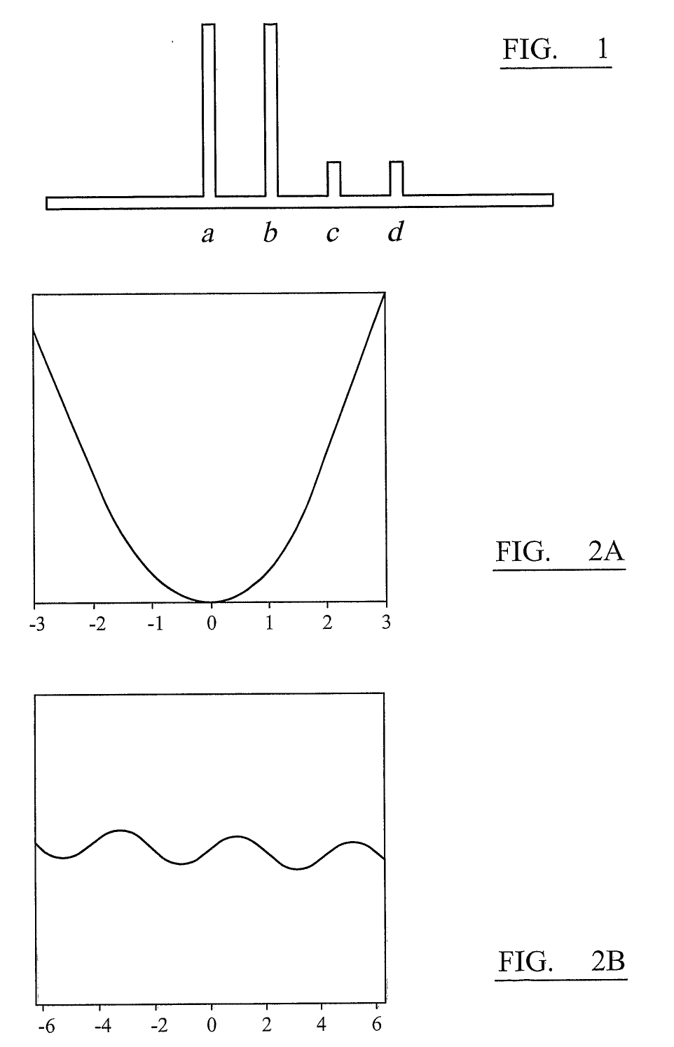

FIG. 1 is a representation of an idealised two person mixture at a locus;

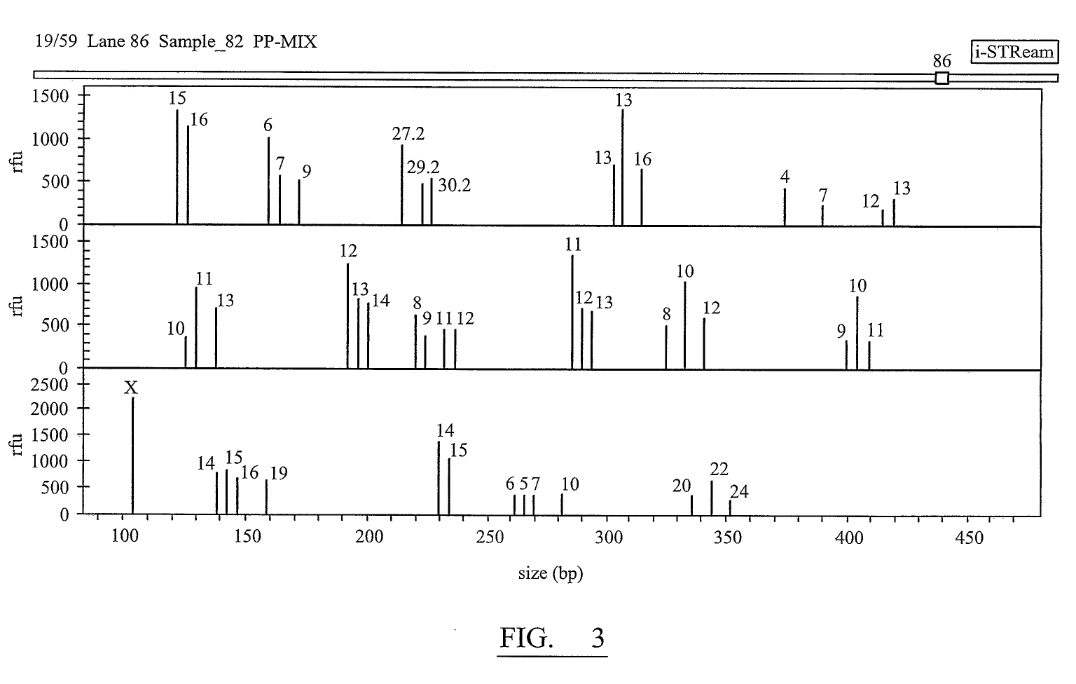

FIG. 2a is an example of an optimisation surface with a well defined minimum;

FIG. 2b is an example of an optimisation surface with an ill-defined global optimum and a number of local minima;

FIG. 3 is a visual representation of a two person mixture profile from Profiler Plus;

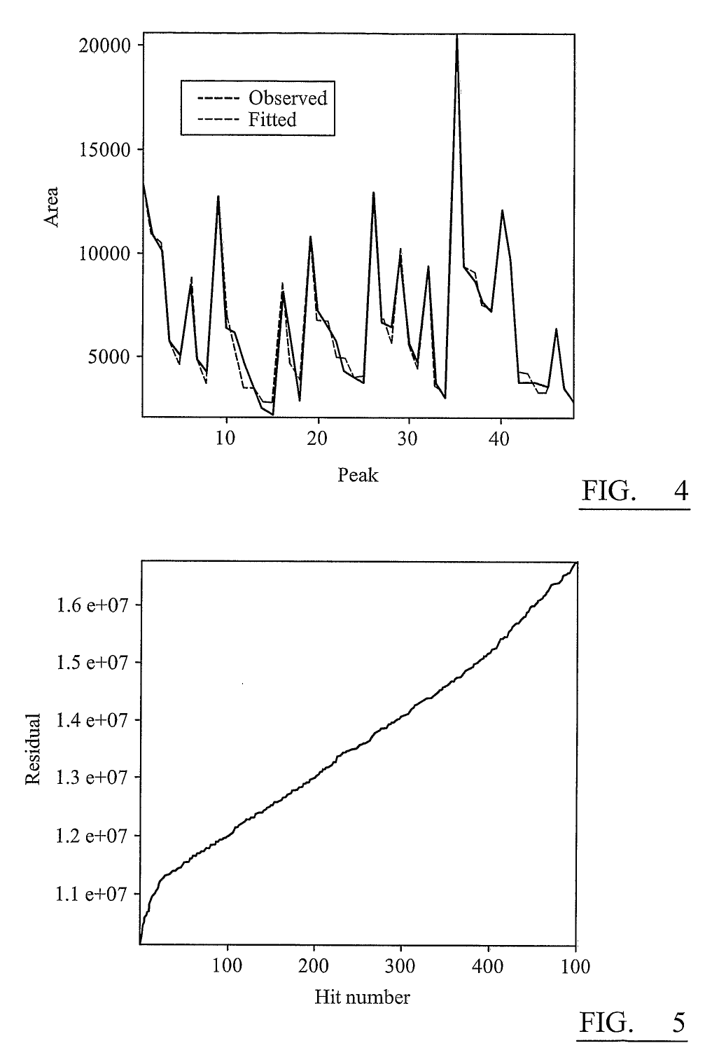

FIG. 4 is a plot of the observed (non-zero peak areas) in order of occurrence, and the expected peak areas from the improved PENDULUM solution of the present invention; and

FIG. 5 shows the value of the residual when the near optimal configurations provided by the present invention are considered.

P. Gill, R. Sparkes, R. Pinchin, C. T. M., J. P. Whittaker and J. Buckleton, “Interpreting simple STR mixtures using allele peak area”, For. Sci. Int 91 (1998), pp. 41-53. provides a method which uses peak area information to help resolve a suspected two person DNA mixture into its components profile. This method was implemented into the computer software package PENDULUM which is described in M. Bill, P. Gill, J. M. Curran, T. Clayton, R. Pinchin, M. Healy and J. Buckleton, “PENDULUM—a guideline-based approach to the interpretation of STR mixtures”, For. Sci. Int 148 (2005), pp. 181-189.

PENDULUM attempts to find the DNA profiles of two contributors and the proportion in which they contributed to the mixture so that the squared difference between the expected peak areas for that profile and the observed peak areas in the experimental results is minimised.

As an example, consider the idealised two person mixture at one locus profile of FIG. 1, that has peak areas associated with each of the alleles of φₐ=990, φ_{b}=1010, φ_{c}=260 and φ_{d}=240.

Using PENDULUM's rule system, this locus would be assessed as a clear major/minor and the only combination considered for the two contributors would be Major: a/b, Minor: c/d. A genotype such as Major: b/c, Minor: a/d is not considered further as PENDULUM eliminates this combination from consideration because although some imbalance between the peaks of a heterozygous genotype is expected, the ratio of the largest peak to the second largest peak in this case exceeds the minimum threshold for heterozygous balance. Hence a disparity in the heights of the peaks of this magnitude is considered infeasible.

Next PENDULUM assesses the mixing proportion. Because this mixture is idealised the mixing proportion can be assessed directly as

$${m}_{x} = \frac{240 + 260}{990 + 1010 + 240 + 260} = \frac{500}{2000} = 0.25$$

This is interpreted as “25% of the peak area is assigned to the minor contributor and 75% is assigned to the major contributor.”

Under the PENDULUM model, the expected contributions to the peak areas are given, for each minor allele by:

$${\hat{φ}}_{i} = E [ {φ}_{i} ] = \frac{{m}_{x} {φ}_{•}}{2}$$

and for each major allele by:

$${\hat{φ}}_{i} = E [ {φ}_{i} ] = \frac{( 1 - {m}_{x} ) {φ}_{•}}{2}$$

where:

$${φ}_{•} = {\sum }_{i} {φ}_{i} .$$

Using these expected values the squared difference, or residual, between the expected and observed values can be calculated thus:

$$RSS ( {m}_{x} ) = {\sum }_{i} {( {\hat{φ}}_{i} - {φ}_{i} )}^{2}$$

The “best fit” that we can achieve at this locus results in a residual of:

$$\begin{matrix}RSS ( {m}_{x} ) = {( 250 - 240 )}^{2} + {( 260 - 240 )}^{2} + {( 1000 - 990 )}^{2} + {( 1000 - 1010 )}^{2} \\ = 4 \times {10}^{2} \\ = 400\end{matrix}$$

PENDULUM attempts to exhaustively find the optimal allocation of genotype to contributors and determine a mixing proportion across all loci, so that the residual is minimised. Exhaustively, in this setting, means that PENDULUM attempts to determine the best mixing proportion, and residual, for all possible genotypes. Understandably, this process can be very computationally demanding, even to the point of impossibility, because of the number of possibilities and hence computations which must be considered.

The type of problem which PENDULUM attempts to solve is technically a combinatorial optimisation problem. This label is applied to problems where one is attempting to optimise a function over a large (but finite and discrete) number of physical states or combinations. As the number of possible combinations increases, an exact solution may not be possible.

As try and address this issue, PENDULUM does employ heuristics in a limited way to reduce the computational complexity. The heuristics in PENDULUM are of two types.

Firstly PENDULUM employs a rule set that uses the peak areas to reduce the possible combinations at a locus. For example, there are twelve possible ways to assign alleles to two contributors for a locus which has three peaks. However, under certain circumstances, one may be able to reduce this number to just three combinations.

Secondly PENDULUM will “unlink” some of the loci with large numbers of combinations. “Unlinking” means that these loci are removed from the initial optimisation, and then recombined at a later time. This is best demonstrated by example.

Consider a DNA profile from the SGM+ multiplex which consists of 11 loci including Amelogenin. With use of the PENDULUM rule set the number of genotypic combinations at each locus in a hypothetical SGM+ profile is as set out in Table 1.

TABLE 1

| Locus | No. of Combinations |
|---|---|
| D3 | 7 |
| VWA | 12 |
| D16 | 12 |
| D2 | 12 |
| Amelogenin | 3 |
| D8 | 12 |
| D21 | 6 |
| D18 | 12 |
| D19 | 12 |
| THO1 | 6 |
| FGA | 1 |

Without the use of unlinking of the “hard” loci, there are 2,257,403,904 combinations to consider. For each of these combinations there are at least 15 steps in the optimisation routine to determine the mixing proportion and subsequently the minimum residual for that combination. By default PENDULUM will unlink the first four “hard” loci. “Hard” loci are two or three peak loci with 7 or 12 possible combinations at each. The facility exists to unlink more loci if desired. This reduces the number of initial combinations to be considered to 186,624. The optimal mixing proportion and residual is determined for all of these combinations, and those with the 500 smallest residuals are retained. The choice of retaining the best 500 combinations or “hits” is the default, but again may be altered by the user.

Once this list of hits has been compiled the following procedure is carried out.

Firstly the ith hit from the “hit list” is taken and the associated mixing proportion, m_{x,i}, is obtained. The residual is calculated at each hard locus for each genotype combination using m_{x,i}. This results in an array of residuals of size n_{TC}. Where n_{TC} is given by the sum of the possible genotype combinations. In the example under consideration n_{TC}=7+12+12+12=43.

Secondly the number different ways there are choosing a residual from the first hard locus, the second hard locus and so on is determined. This is number is n_{TA} and it is given by the product of the hard loci combinations. In the example under consideration this would be n_{TA}=7×12³=12,096.

Finally the sum of the residuals for each of the arrangements is added it to the residual of the ith hit to form a new hit list.

This process is repeated for every hit in the hit list. So, in the example, this results in an extra 12,096×500=2,592,000 iterations. This may sound substantial, but total number of combinations/iterations is less than 0.13% the original number of combinations (and less than 0.012% of the number of combinations that would be necessary without use of the rule set). However, this example can be quickly rendered intractable, by increasing the number of loci from 11 to 16 (say if a Profiler Plus multiplex were to be used instead).

Referring to Table 2 and the number of genotypic combinations at each locus in a hypothetical Profiler+profile it contains, the number of combinations in this example is 4.88×10¹². If the first four hard loci are removed this still leaves 403,107,840 combinations. If six hard loci are removed, then there are 2,799,360 combinations to look at, but an additional 870,912,000 combinations to consider in the post optimisation phase.

TABLE 2

| Locus | No. of Combinations |
|---|---|
| D3S1358 | 7 |
| TH01 | 12 |
| D21S11, | 12 |
| D18S51 | 12 |
| PENTA_E | 1 |
| D5S818 | 13 |
| D13S317 | 12 |
| D7S820 | 6 |
| D16S539 | 12 |
| CSF1PO | 12 |
| PENTA_D | 6 |
| Amelogenin | 1 |
| VWA | 6 |
| D8S1179 | 5 |
| TPOX | 6 |
| FGA | 12 |

Whilst PENDULUM is provided with a rule set and some heuristic techniques to reduce the computational burden, therefore, as the number of loci increase, exhaustive (or near exhaustive) examination of all feasible genotypes will quickly become impossible.

The present invention has amongst it aims to provide an alternative approach which reduces the computational burden to acceptable levels.

Instead of working through all the possibilities, the approach of the present invention uses a different approach to solving large combinatorial optimisation problems.

As a first step, an initial random starting configuration or combination is picked. This is then processed to evaluate the objective function. The objective function is the function that one is attempting to minimize. In the PENDULUM situation, the objective function is the residual function.

As a second step, another random configuration is chosen in each of an arbitrary number of iterations. If the configuration is denoted x′ and the corresponding value of the objective function is denoted as f(x′), then if the value of the objective function at the new configuration is lower, i.e. f(x′)<f(x), then the current optimal configuration is changed to x′, i.e. let x→x′.

In this way, the method quickly identifies an optimal solution.

The invention has identified a number of alternatives for choosing the random configuration in the PENDULUM setting.

Firstly, it is possible to pick genotype combinations at random. In this instance, a locus is chosen at random, and then a genotype combination is selected at random from the possibilities at that locus. The possibilities can be unconstrained in that they disregard the PENDULUM rule set for allowable genotypes or constrained. For reasons discussed in more detail below, the other possibilities appear to be better ways forward in the PENDULUM context.

Secondly, it is possible to pick the best genotype combinations at random. The second method involves picking a locus at random, and then choosing the genotype that provides minimal residual across all loci. Randomness is still desirable so as to avoid the risk of getting stuck at a local minima—for instance, if one were to start at the first locus, find the best residual, move to the second locus find the best residual and so on.

Thirdly, it is possible to use an optimisation algorithm which has a non-zero probably of accepting a configuration that is worse than the current configuration. This probability of acceptance decreases as the number of iterations in the optimisation procedure increases. However, it does provide a way of checking whether an optimised minimum is one or is a false minimum.

Fourthly, it is possible to provide multiple runs of the random choice and then iterate process and consider the combined results together.

The problem with the first possibility can be seen from considering two cases, one in which the optimisation surface is steep and there is a single minima, FIG. 2a, and another in which there are a series of local minima, FIG. 2b.

FIG. 2a is an example of an optimisation surface with a well defined minimum. FIG. 2b is an example of an optimisation surface with an ill-defined global optimum and a number of local minima. The first possible way of optimising will work well with the former but usually not the latter. The poor performance of the algorithm that relies on random perturbations of genotype combinations at a locus suggests that the optimisation surface in difficult PENDULUM problems (which are the ones that require the most computation) is more like FIG. 2b than FIG. 2a. Therefore, the second possibility, which moves locus by locus and optimises locally, or the third possibility or the fourth possibility, seem to provide better methods as they can escape local minima.

Using one of these refined methods for optimisation, the invention provides a quicker and computationally more practical way of reaching the optimal solution.

As well as finding the optimal configuration, PENDULUM produces a rank list of hits—solutions which are close in terms of the residual to the optimal solution. This is an acknowledgement that whilst the optimal solution is technically the best in terms of explaining the observed data, the model for the expectation does not describe the inherent stochastic variation in electropherogram (EPG) data. Further details of these variations are provided for in P. Gill, J. M. Curran and K. Elliot, A graphical simulation model of the entire DNA process associated with the analysis of short tandem repeat loci, Nucleic Acids Research 33 (2005), pp. 632-643. Therefore the “true” profiles of the contributors may not be the optimal solution, but near to the optimal solution.

The improved speed with which the proposed algorithm of the present invention converges to the optimum means that maintaining a list of the solutions considered throughout the simulation process may not contain many of the near neighbours of the optimal solution.

To over this difficulty small systematic perturbations of the optima solution are considered after convergence has been achieved. These perturbations are labelled first order and second order perturbations.

First order perturbations consist of considering all the changes of one genotype at one locus at a time. There are

$${\sum }_{l = 1}^{L} ( {n}_{l} - 1 )$$

choices for the first order perturbations where nₗ is the number of combinations possible at the lth locus, and L is the number of loci in the multiplex.

Second order perturbations consist of the changes of one genotype at each of two loci. There are

$${\sum }_{i = 1}^{L - 1} [ ( {n}_{i} - 1 ) {\sum }_{j = i + 1}^{L} ( {n}_{j} - 1 ) ]$$

possible combinations.

The method considers all first order and all second order perturbations to the optimal solution and retains the best 2500 by default. If the number of first order and second order does not exceed 500 then third order perturbations or higher can be considered.

By way of actual worked example, the type of profile considered in Table 2 can be processed. FIG. 3 provides a visual representation of the mixture. This problem is not resolvable in real time with the current version of PENDULUM. The improved PENDULUM method algorithm converges and produces a hit list of length 500 in less than 10 seconds running on a 2.8 GHz Pentium 4 processor with 1 GB of RAM. The algorithm runs five random starting configurations and allows each optimisation procedure to run for 1,000 iterations. The multiple random starts provide further protection against biases that may be induced from the starting position.

The results of the process can be displayed in a plot of the observed (non-zero peak areas) in order of occurrence, and the expected peak areas from the improved PENDULUM solution, FIG. 4. This shows how well the optimal fit does indeed fit the observed data. The solid line is the observed non-zero peak areas plotted in order of input. The dotted line is the fitted (or expected) peak areas given by the optimal solution. The residual for this solution is approximately 1.1×10⁷. This may seem large, but given the magnitude of the input values (from 2,000 to 20,000) and that the residual is accumulated across 16 loci, this number is not unusual.

FIG. 5 shows how the residual changes as the configuration moves away from the optimal solution. There appears to be an initial step change, followed by a linear increase.

Resolution of DNA mixtures into contributor profiles is an important process in case work where it may help reduce the number of combinations that need to be considered in likelihood ratio calculations. PENDULUM has proved very useful in this process. Furthermore PENDULUM has aided the intelligence community in providing possible leads in cases which may have stalled for lack of additional information. However, PENDULUM, as it is currently implemented, is not easily extended to deal with multiplexes with increasingly larger numbers of loci. This invention provides a possible solution to this. Rather than exhaustively examine all genotype combinations, an heuristic approach, potentially using Monte Carlo techniques, is taken to find the best combination of contributor profiles. This method, whilst not guaranteed to find the optimal solution in a finite amount of time, appears to do so quickly and efficiently and more importantly in cases which PENDULUM cannot currently deal with.

The technique of the present invention and the existing PENDULUM approach could be deployed in a single system. The existing approach could be used where appropriate, but with a switch to the technique of the present invention being made where the problem could not be resolved in a practical timeframe by the existing technique. Because the new approach is tailored to be consistent with the type of investigation and type of result provided by the existing approach, a seamless transfer between the two can be provided.

The improved approach is able to rapidly find the “best” allocation of genotypes to contributors, and through some structured perturbations produce a ranked list which can then be used to search against DNA profile containing databases, such as The National DNA Database, Registered Trade Mark, to provide intelligence to lead subsequent law enforcement activities.

1. A method of analyzing, the method including i) obtaining from an analysis of a DNA containing sample an observed result, the observed result relating to a value set for a characteristic of the DNA; ii) randomly selecting a selected value set for that DNA characteristic and generating an expected result from that selected value set; iii) comparing the observed result and the expected result and quantifying the difference there between; iv) considering the selected value set to be the optimal match for the value set for the DNA of the DNA containing sample; v) randomly selecting a different selected value set for that DNA characteristic and generating another expected result from that selected value set; vi) comparing the observed result with the another expected result and quantifying the difference there between; vii) replacing the existing value set considered to be the optimal configuration with the different selected value set of step v) if a criteria is met; viii) repeating steps v), vi) and vii) at least 10 times; ix) the last optimal match being taken to be the optimal match for the value set for the DNA of the DNA containing sample.

2. A method according to claim 1 in which the observed result and the expected result relate to one or more peak areas or peak heights at one or more allele sizes for one or more loci and reflects the mixing proportion of the different contributors to the mixed sample.

3. A method according to claim 1 in which the selected value set is selected at random from amongst all possible selected value sets.

4. A method according to claim 1 in which the locus is selected at random from amongst a sub-set of all possible selected value sets.

5. A method according to claim 4 in which the sub-set is constraining compared with all possible selected value sets by excluding possible selected value sets for which one or more criteria are not met.

6. A method according to claim 1 in which the selected value set is selected at random from amongst a sub-set of all possible selected value sets, the sub-set being formed by choosing a locus at random, with the selected value set being the value set which provides the optimal match and/or minimal residual across all loci considered in the method and/or considered in the analysis of the DNA containing sample.

7. A method according to claim 1 in which the first selected value set is replaced by another selected value set as a result of step vii) in the method.

8. A method according to claim 7 in which the different selected value set is selected at random from amongst a sub-set of all possible selected value sets, the sub-set being formed by constraining compared with all possible selected value sets, the constraining excluding one or more of the possible loci from being selected.

9. A method according to claim 8 in which one or more of the excluding loci are included in the method later by obtaining an initial optimal match using the method, and then performing steps v), vi), vii) and viii) in respect of one or more of those excluded loci.

10. A method according to claim 1 in which the criteria of step vii) are met where the quantification of the difference is smaller for that value set compared with that for the value set considered to be the optimal configuration before that value set was considered.

11. A method according to claim 10 in which the criteria of step vii) is only met in a fraction of instances in which the quantification of the difference is smaller for that value set compare with that for the value set considered to be the optimal configuration before that value set was considered.

12. A method according to claim 1 in which the method provides for at least 500 repeats of steps v), vi) and vii).

13. A method according to claim 1 in which the method repeats steps ii), iii), iv), v), vi), vii) and viii) a plurality of times before determining the solution of step ix).

14. A method according to claim 1 in which the optimal match details the selected value set which best match's the selected value set for the observed result.

15. A method according to claim 1 in which the last optimal match forms the starting point for the generation of a number of further possible matches and the further possible matches are ranked according to likelihood and/or the difference quantification.

16. A method according to claim 1 in which the optimal match is searched against one or more databases.

17. A method according to claim 1 in which further possible matches include one or more value sets considered in the method for reaching the optimal match, but not being retained as the optimal match.

18. A method according to claim 1 in which further possible matches are generated from a last optimal match by applying a perturbation to the last optimal match.

19. A method according to claim 18 in which one or more first order and/or second order and/or higher order perturbations are applied.

20. A method according to claim 19 in which all possible first order and/or second order and/or higher order perturbations are considered.

21. A method according to claim 20 in which a random sample of first order and/or second order and/or higher order perturbations are considered.

22. A method according to claim 18, in which the difference between the expected result for each perturbation and the observed result are quantified.

23. A method according to claim 17, in which a number of the further matches meeting a criteria are selected to form a ranked list.

24. A method according to claim 23 in which the criteria is the N further possible matches which have the lowest difference compared with the observed result, where N is a positive integer.

25. A method according to claim 18 in which perturbations of a higher order than first or second are used if the first and second order perturbations do not generate the required level of N or do not generate the required level of N below a threshold value for the quantification of the difference.

26. A method according to claim 1 in which the method is used in a first set of circumstances, with an alternative method being used in a second set of circumstances, the first set of circumstances being the number of loci for which the DNA is analyzed or which are included in the observed result is greater than a threshold number.
